(19) United States
(12) Patent Application Publication
(10) Pub. No.: US 2008/0082264 A1
(43) Pub. Date: Apr. 3, 2008

(54) GPS route creation, photograph association, and data collection

(75) Inventors: Ryan Hill, Irvine, CA (US); Jeyhan Karaoguz, Irvine, CA (US); Nambirajan Seshadri, Irvine, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/593,912

(22) Filed: Nov. 7, 2006

Related U.S. Application Data
(60) Provisional application No. 60/843,661, filed on Sep. 11, 2006.

(51) Int. Cl. G01C 21/00

(52) U.S. Cl. 701/213

(57) ABSTRACT

Global Positioning System (GPS) route creation via server interaction or wireless terminal collection creates a GPS route data file that includes starting location GPS coordinates, ending location GPS coordinates, and at least one way point location data element. Each way point location data element includes respective way point location GPS coordinates and a respective link to a corresponding digital photograph data file. Wireless terminals having corresponding sensors collect local meteorological conditions that are associated with digital photographs and GPS coordinates at capture. The digital photographs, GPS coordinates at capture, and local meteorological conditions are used to produce local weather reports for requesting client terminals. Virtual tours could also be conducted using the captured digital photograph files.

### CROSS REFERENCES TO RELATED APPLICATIONS

The present application claims priority to Provisional Application Ser. No. 60/843,661 filed on Sep. 11, 2006, the disclosure of which is incorporated herein in its entirety by reference for all purposes.

### BACKGROUND OF THE INVENTION

1. Technical Field of the Invention

This invention relates generally to mobile communications and Global Positioning System (GPS) operations.

2. Description of Related Art

Communication systems technology has advanced greatly over the last 10 years. Mobile communication systems are now ubiquitous and service literally billions of subscribers. Mobile communication systems include cellular communication networks, Wireless Local Area Networks (WLANs), Personal wireless Area Networks (PANs), Worldwide Interoperability for Microwave Access (WiMAX) networks, satellite communication networks, among other wireless communication networks. Currently, handheld devices, automobile-based communication systems, laptop personal computers, desktop personal computers, and a myriad other electronic devices include wireless interfaces. These wireless interfaces support communication with other wireless devices, as well as with communication infrastructures such as the networks described above.

The Global Positioning System (GPS) allows a GPS receiver within a wireless device to locate its position upon the Earth. GPS receivers are typically accurate to within a number of feet of resolution. The cost of GPS receivers continues to decrease such that GPS receivers are now deployed within handheld devices, such as cellular telephones, WLAN telephones, data terminals, and other portable devices.

Automotive and hand-held GPS terminal navigation systems are now in widespread use. These GPS navigation systems determine a current position of a respective GPS receiver, receive information regarding a desired destination, and typically plot both a current position of the GPS receiver and a route to the desired destination on a map. Determination of the route is typically based upon preferences such as road type, shortest distance, avoiding certain areas, waypoint selection, and additional information. The GPS navigation system then computes a route based upon the user preferences and indicates to the user how to travel along the route.

Information used by the GPS navigation system regarding destination locations, road types, waypoints, etc. are often incorrectly represented in a database used by the GPS navigation system. With this incorrect database information, the GPS navigation system may therefore provide directions to a non-desired location, provide an undesirable route, or otherwise function in an undesirable manner. Thus, while the user of the GPS navigation system would be following directions as usual along the determined route, the user would actually be doing so blindly, to his or her detriment. Thus, improvements are needed in the construct and operation of GPS navigation systems, databases that are used by GPS navigation systems, and data relied upon by the GPS navigation systems.

### BRIEF SUMMARY OF THE INVENTION

The present invention is directed to apparatus and methods of operation that are further described in the following Brief Description of the Drawings, the Detailed Description of the Drawings, and the Claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a system diagram illustrating a communication system constructed and operating according to one or more embodiments of the present invention;

FIG. 2 is a flow chart illustrating GPS route generation operations according to a first embodiment of the present invention;

FIG. 3 is a flow chart illustrating GPS route generation operations according to a second embodiment of the present invention;

FIG. 4 is a diagram illustrating structure of a GPS route data file according to an embodiment of the present invention;

FIG. 5 is a diagram illustrating structure of a digital photograph data file according to an embodiment of the present invention;

FIG. 6 is a flow chart illustrating GPS route usage operations according to an embodiment of the present invention;

FIG. 7 is a topical area diagram with which operation of the present invention is described;

FIG. 8 is a block diagram illustrating a wireless terminal constructed according to an embodiment of the present invention;

FIG. 9 is a block diagram illustrating a server constructed according to one or more embodiments of the present invention;

FIG. 10 is a flow chart illustrating map and digital photograph data file server operations according to an embodiment of the present invention;

FIG. 11 is a flow chart illustrating digital photograph data file and meteorological data server operations according to a first embodiment of the present invention;

FIG. 12 is a flow chart illustrating digital photograph data file and meteorological data server operations according to a second embodiment of the present invention; and

FIGS. 13-15 are pictorial representations of a three-dimensional graphical model that may be used to provide a virtual tour according to aspects of the present invention.

### DETAILED DESCRIPTION OF THE INVENTION

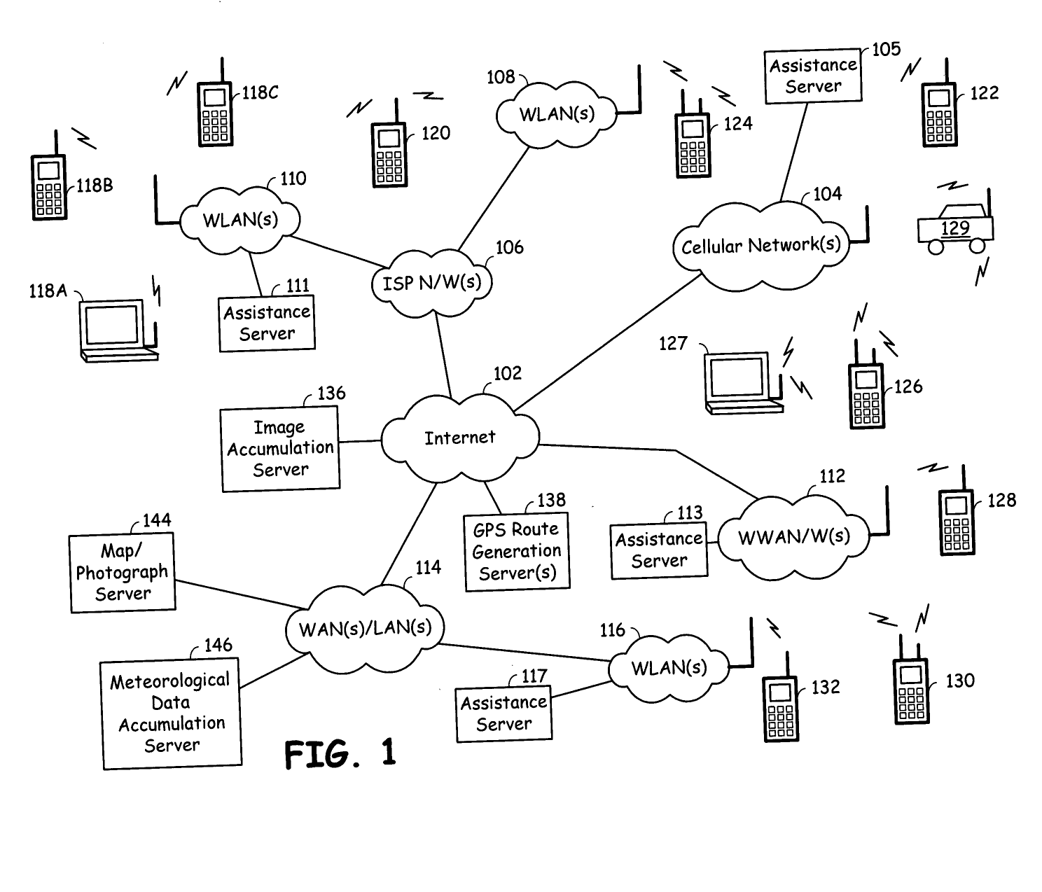

FIG. 1 is a system diagram illustrating a communication system constructed and operating according to one or more embodiments of the present invention. A plurality of interconnected communication networks includes the Internet 102, one or more cellular networks 104, one or more Internet Service Provider (ISP) networks 106, one or more Wireless Local Area Networks (WLAN) 108, 110, and 116, one or more Wireless Wide Area Networks (WWAN(s)) 112 such as a Worldwide Interoperability for Microwave Access (WiMAX) network, and one or more Wide Area Networks/Local Area Networks (WANs/LANs) 114. The communication infrastructure of FIG. 1 supports a number of differing wireless communication interfaces. For example, WLANs 108, 110, and 116 support communications with wireless terminals having WLAN interfaces. For example, WLAN 108 supports WLAN communications with wireless terminal 120 and dual mode wireless terminal 124. WLAN 110 supports WLAN communications with wireless terminals 118A, 118B, 118C, and 120. Further, WLAN 116 supports WLAN communications with wireless terminal 132 and dual mode wireless terminal 132.

Cellular network(s) 104 support cellular communications with wireless terminal 122, dual mode wireless terminal 124, wirelessly-enabled automobile 129, dual mode network-enabled laptop computer 127, and dual-mode wireless terminal 126. Dual-mode wireless terminal 124 also supports wireless communications with cellular network(s) 104 and WLAN 108. As is generally known, a dual-mode terminal may include two or more wireless interfaces, each of which wirelessly interfaces the wireless terminal with a respective wireless communication network or interface standard. The cellular network 104 operates according to one or more cellular protocol interface standards, such as the GSM standard, the WCMA standard, the UMTS standard, one or more CDMA standard, and/or another cellular standard. The WiMAX network 112 supports dual-mode terminal 126, dual-mode laptop computer 127, wireless terminal 128, and dual-mode wireless terminal 130. Further, WLAN 1116 supports wireless communications with wireless terminal 132.

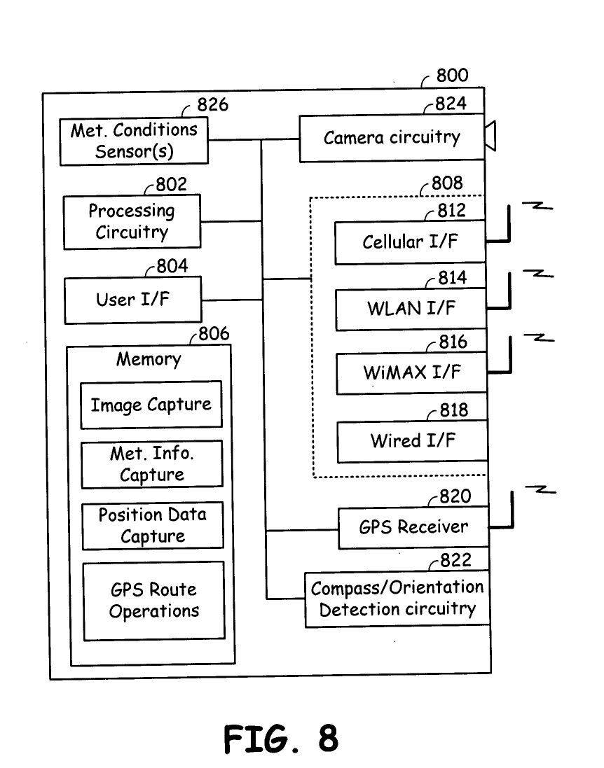

Each of the wireless terminals illustrated in FIG. 1 includes a GPS receiver. The GPS receiver of each wireless terminal is capable of determining its current location by interacting with three or more servicing GPS satellites. As will be further described hereinafter, these wireless terminals may use assistance-GPS system. The general structure of wireless terminals will be described with reference to FIG. 8.

The wireless terminals of FIG. 1 may employ Assisted-GPS (A-GPS) operations in determining their GPS positions. A-GPS is primarily a handset-based technology that uses enhancements to the network to provide additional accuracy and speed of location fix. A-GPS receivers are connected to the network at various known geographic points to provide additional data to the handset, greatly reducing the time needed to get positioning information and thereby allowing longer battery life. A-GPS variants can provide better in-building location coverage and accuracy as well.

Generally, A-GPS works by providing a GPS reference network in which a series of receivers have a clear view of the sky and can operate continuously. This reference information is then made available to an “assistance server” that may be a dedicated assistance server 105, 111, 113, or 117, or that may be a functional component of a servicing network, such as a base station of the cellular network, an Access point of a WLAN 110, 112, or 116, or a base station of the WiMAX N/W 112, for example. In regular GPS networks there are only GPS satellites and GPS receivers. In A-GPS networks, the receiver, being limited in processing power and normally under less than ideal locations for position fixing, communicates with the assistance server that has high processing power and access to a reference network. Since the A-GPS receiver of the wireless terminal and the Assistance Server share tasks, the GPS location determination process is quicker and more efficient than regular GPS, albeit dependent on cellular or other wireless coverage. The assistance server has the ability to access information from the reference network and has computing power far beyond that of the GPS receiver. With assistance from the network, the GPS receiver of the wireless terminal operates more quickly and efficiently than it would unassisted, because a set of tasks that it would normally handle is shared with the assistance server. The resulting AGPS system boosts performance beyond that of the same receiver in a stand-alone mode.

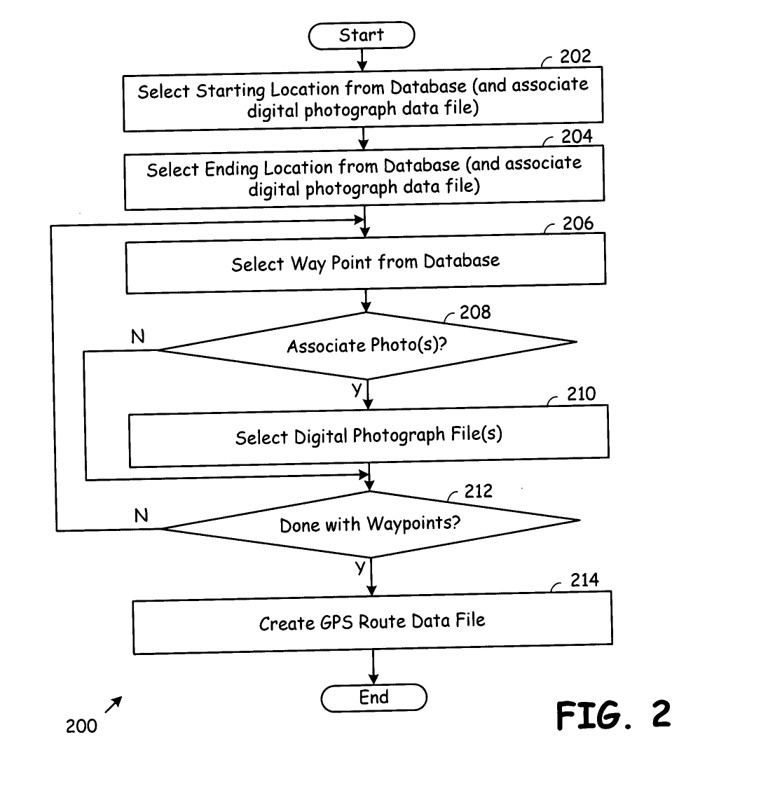

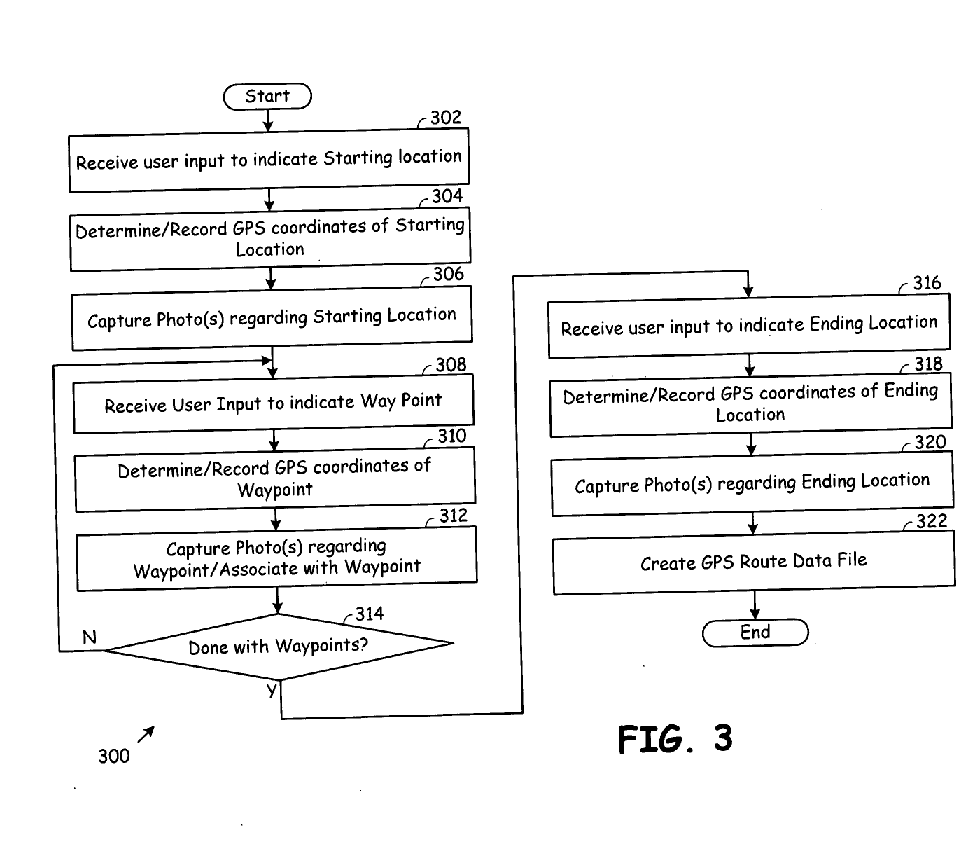

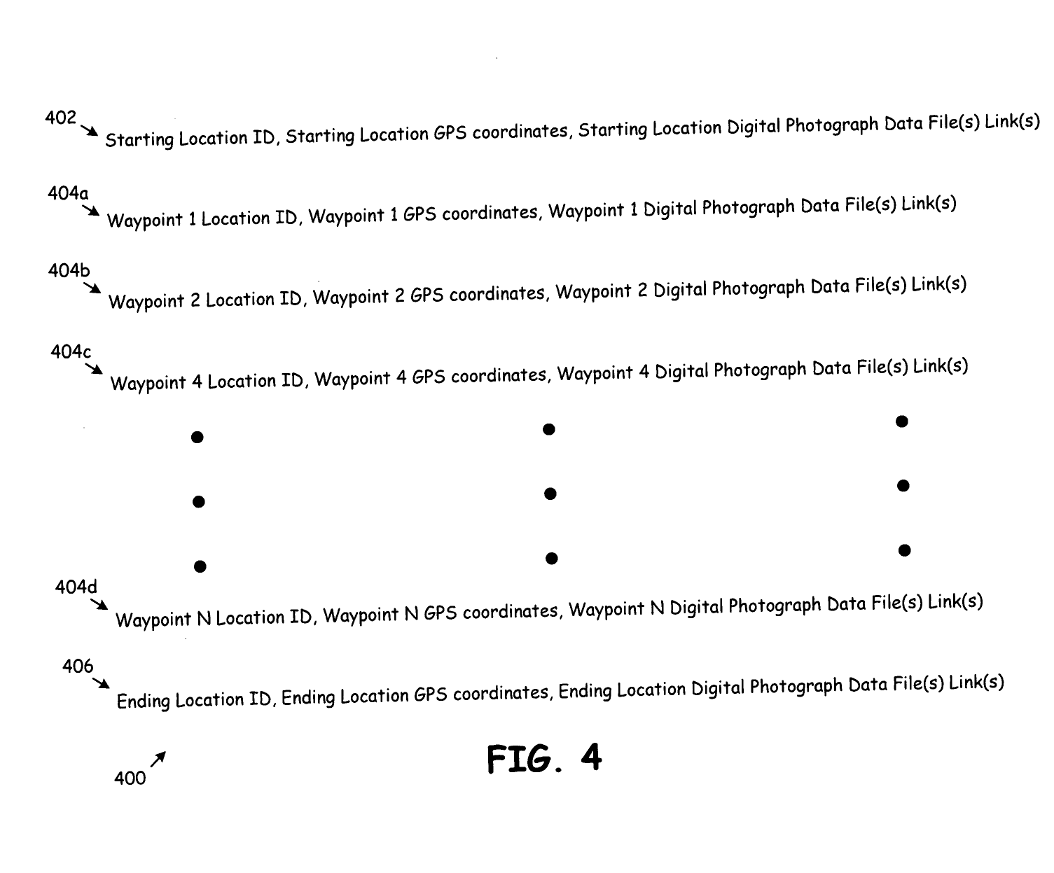

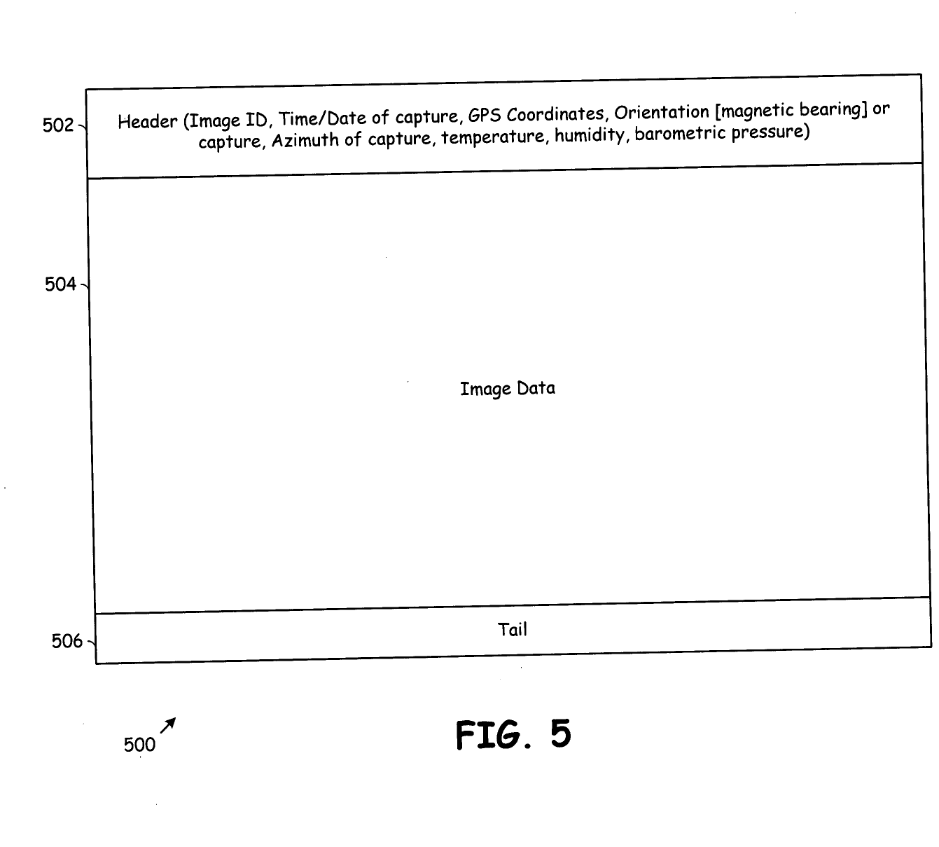

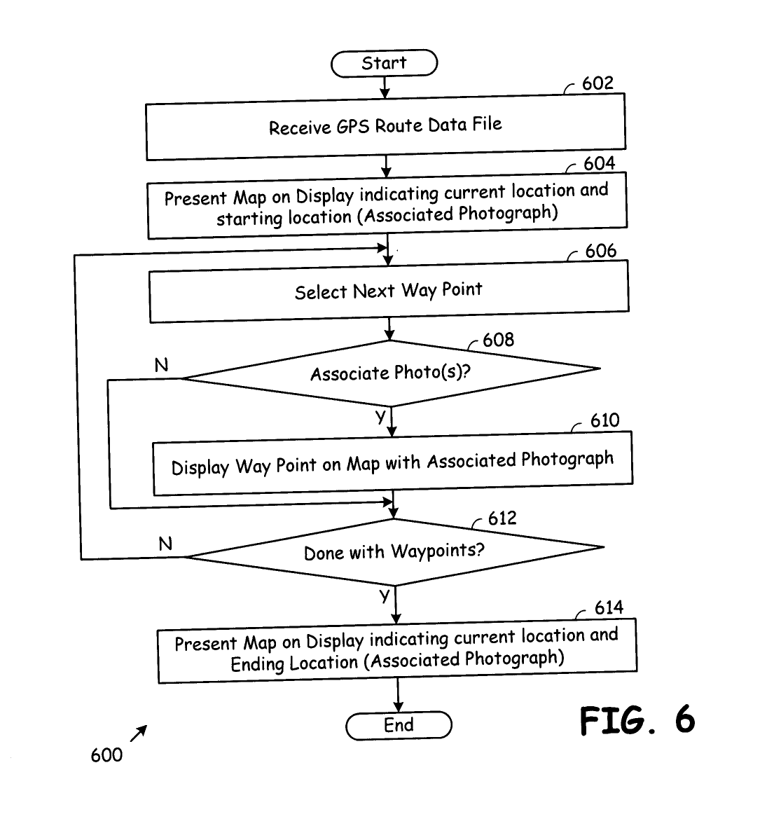

The system of FIG. 1 also includes an image accumulation server 136, a map/photograph server 144, one or more GPS route generation servers 138, a meteorological data accumulation server 146, E commerce server 138 and a plurality of assistance servers 111, 105, 113, and 117. According to a first aspect of the present invention, a user may interact with the GPS route generation server 138 to create a GPS route. The manner in which the GPS route is created will be further described with reference to FIGS. 2 and 3. An example structure of the GPS route that is created will be described further herein with reference to FIG. 4. The manner in which this GPS route may be used by any of the wireless terminals of FIG. 1 will be further described with reference to FIG. 6. Each of the wireless terminals of FIG. 1 may have camera circuitry that is operable to capture digital photographs. According to one aspect of the present invention, each of the wireless terminals is operable to create digital photograph data files that not only include image data but also include GPS coordinates of capture of the image data. An example structure of a digital photograph data file is further described herein with reference to FIG. 5.

Further, each of the wireless terminals may also include compass/orientation detection circuitry that records the capture orientation and capture azimuth of the digital photograph. Moreover, each of the wireless terminals may include meteorological information sensors that are operable to detect meteorological conditions present with the wireless terminal. These meteorological conditions may include temperature, humidity, barometric pressure, or other meteorological conditions. Some are all of this information may be appended to or included a digital photograph data file that includes the image captured.

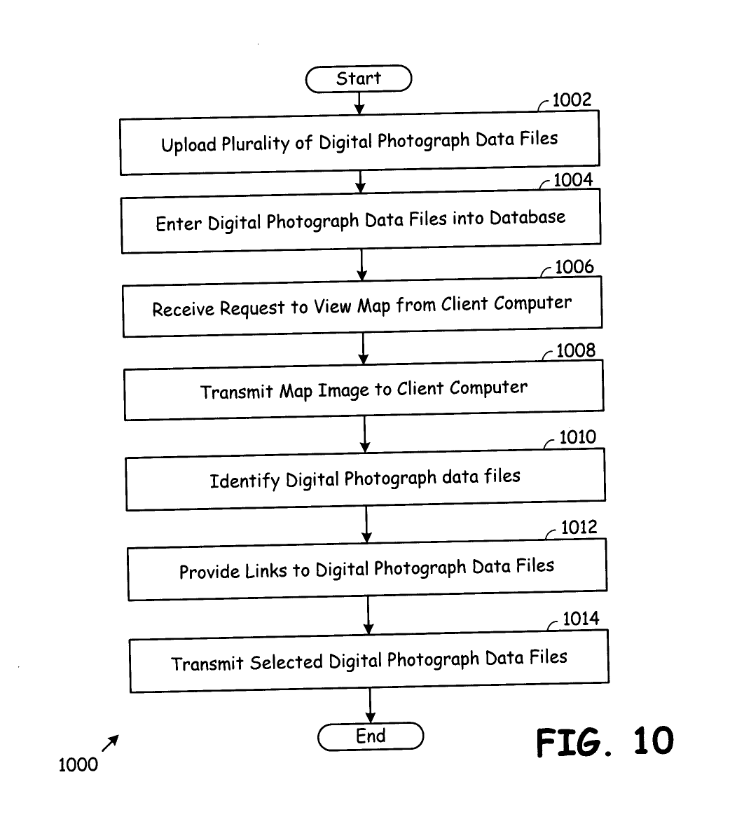

According to other aspects of the present invention, when any of the wireless terminals captures a digital photograph, an appends capture information may include meteorological data, the wireless terminal may upload the digital photograph data file to image accumulation server 136, map/photograph server 144, and/or meteorological data accumulation server 146. The meteorological data accumulation server 146 then operates to use the meteorological data retrieved from the wireless terminals to service a client device requesting local meteorological conditions. These operations will be described further herein with reference to FIGS. 10-12.

FIG. 2 is a flow chart illustrating GPS route generation operations according to a first embodiment of the present invention. Generally, the operations 200 of FIG. 2 may be initiated by any client device that is communicatively coupled to the GPS route generation server 138 of FIG. 1. Thus, any of the wireless devices of FIG. 1 may communicate with GPS route generation server 138 to execute the operations 200 of FIG. 2 in cooperation with the GPS route generation sever 138. In addition, other digital computers that communicatively couple to the GPS route generation server 138 in a wired manner may also execute the operations 200 of FIG. 2. Further, a user local to the GPS route generation server 138 may also execute the operations 200 of FIG. 2 to generate a GPS route. A database referred to in the operations of FIG. 200 would be stored locally at the GPS route generation server 138 or at another location that is accessible to GPS route generation server.

The operations 200 of FIG. 2 commence with selecting a starting location from a database (Step 202). Included with the starting location are starting location GPS coordinates. The operation of Step 202 may include selecting a digital photograph data file that is associated with the starting location. The digital photograph, in one example, represents a landmark, building, or other reference location proximate the starting location. Operation continues with selecting an ending location from the database (204). The operations at Step 204 may include also associating the ending location with a digital photograph data file that is stored at the GPS route generation server 138 or elsewhere. Alternatively, the digital photograph data file associated with the starting location at Step 202 and the ending location at Step 204 may be provided by a servicing client device or may be accessed from another server, e.g., image accumulation server 136, or map/photograph server 144 and then associated with the starting location or ending location.

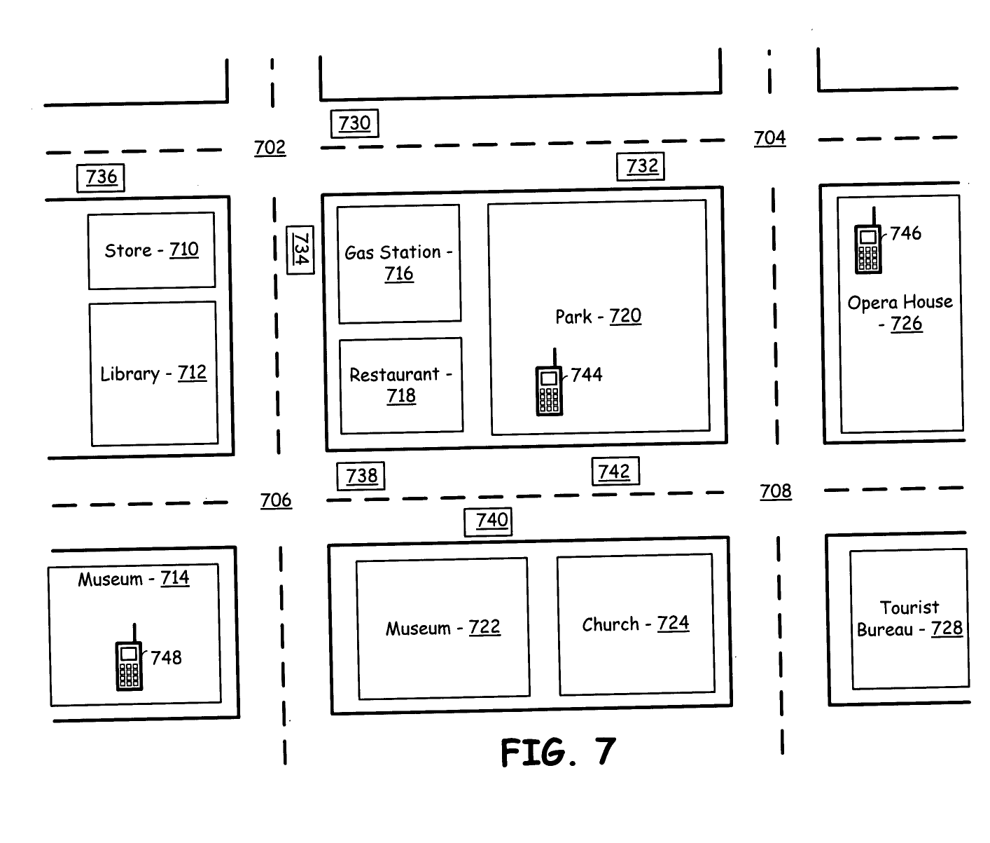

Operation 200 of FIG. 2 continues with selecting a way point location from the database (Step 206). The way point location selected at Step 206 would be a physical location along the GPS route that the creator of the GPS route deems important in following the directions provided by the GPS route. The way point location may be a gas station, a statue, a park, or another feature along the route that allows the user of the GPS route when following the directions to verify easily that he or she is correctly following the route. The GPS route created according to the present invention may be used in traveling from one point to another point, for example. Further, the GPS route may be used as a directed tour. With the directed tour, each way point location may correspond to a location of interest with the tour. A GPS route that is used for a directed tour may be particularly useful at tourist locations by tourist that do not speak the native language and cannot read a sign associated with the points of interest. Further examples of the creation and use of the GPS route according to the present invention are described further with reference to FIG. 7.

For each way point location selected at Step 206, the creator of the GPS route may choose to associate a photo with the way point location (Step 208). When the creator of the GPS route chooses to associate a photo with the way point location, the creator identifies a location of a digital photograph data file corresponding to the way point location (Step 210). In associating any of the starting location, ending location, or way point location photograph, the GPS route generation server 138 may investigate the GPS location of the digital photograph filed to ensure that the digital photograph file correctly relates to the GPS coordinates of the starting location, ending location, or way point location. The user may continue to select way point locations at Step 206 with operation returning from Step 212-206. However, at some point, the user will be completed with entering way point location information as determined at Step 212.

At this point, the GPS route generation server 138 creates a GPS route data file that includes the starting locations GPS coordinates, the ending locations GPS coordinates, and at least one way point location element (Step 214). Each way point location element includes a respective way point location identifier, respective way point location GPS coordinates, and may include a respective link to a corresponding digital photograph data file. The operation at Step 214 may further include transmitting the GPS route data file from the GPS route generation server 138 to any other wireless terminal or wired terminal. For example, the GPS route data file created by the GPS route generation server 138 may be transmitted to wireless terminal contained in automobile 129 of FIG. 1 for use by the automobile 129 in following the directions to reach an ending location. If one friend wanted another friend to visit a particular location, and the first friend knew the starting location, the first friend could create the GPS route data file to assist the second friend (driver of the automobile 129) in reaching the ending location. In such case, the first friend could use wirelessly enabled laptop computer 118 to interact with GPS route generation server 138 to create the GPS route data file and then request that the GPS route data file be transmitted to the automobile 129 for use by the second friend (driving automobile 129).

In another example of the operation according to the present invention, one friend (or tour guide operator) could create a guided tour for another friend (or customer) using the GPS route generation server 138. Upon completing the guided tour, the GPS route generation server 138 would create the GPS route data file. Upon completion, the creator of the GPS route data file would then request the GPS route data file to be sent to a user of wireless terminal 120, for example, or simply to be stored for access by the user of wireless terminal 120. The second friend (or customer) could then use the GPS route to take the guided tour.

FIG. 3 is a flow chart illustrating GPS route generation operations according to a second embodiment of the present invention. As compared to the operations 200 of FIG. 2, the operations 300 of FIG. 3 are employed by a user of a wireless terminal while traveling along a route for which the user desires to create the GPS route. As will be described further with reference to FIG. 7, a user of wireless terminal may desire to create driving instructions or a guided tour for use by his or her friends or business associates. In such case, the user of the wireless terminal would take the wireless terminal along a desired route.

The user of the wireless terminal would commence operation by providing user input to the wireless terminal to indicate presence at a starting location (Step 302). In response thereto, the wireless terminal would determine starting location GPS coordinates (Step 304). The wireless terminal would then store a starting location identifier and the starting location GPS coordinates at Step 304. Optionally, the user of the wireless terminal may cause the wireless terminal to capture a photograph regarding the starting location (Step 306). The user of the wireless terminal then proceeds along his or her desired route. Along the way, the user of the wireless terminal would from time to time indicate to the wireless terminal that a way point location has been reached (Step 308). Upon this indication by the user, the wireless terminal determines and records GPS coordinates at the way point location (Step 310). The user of the wireless terminal may at that point in time cause the wireless terminal to capture a digital photograph regarding the way point location and associate the digital photograph with the way point location (Step 312). Of course, not all way point locations would have associated therewith digital photographs. However, many way point locations could be associated with digital photographs that are captured by the wireless terminal.

The user of the wireless terminal then continues along his or her desired route and continues to indicate presence at way point locations and capture photographs at the way point locations by returning from Step 314 to Step 308. Once the user is done with collecting way point location information, operation proceeds to Step 318 where the user of the wireless terminal indicates presence at an ending location 316. Upon this indication by the user of the wireless terminal, the wireless terminal determines and records the GPS coordinates of the ending location (Step 318). The user of the wireless terminal may also cause the wireless terminal to capture a photograph regarding the ending location (Step 320). Finally, when the route data has been finally collected, the wireless terminal creates a GPS route data file (Step 322). This GPS route data file includes the starting location GPS coordinates, the ending location GPS coordinates, and at least one way point location data element. Each way point location data element includes respective way point location GPS coordinates and may include a respective link to a corresponding digital photograph data file. From Step 322, operation ends.

FIG. 4 is a diagram illustrating structure of a GPS route data file according to an embodiment of the present invention. As is shown, the GPS route data file 400 includes a starting location data element 402, a plurality of way point location data elements 404A-404D, and an ending location data element 406. The starting location data element 402 includes a starting location ID, starting location GPS coordinates, and may include one or more starting location digital photograph data file links. Each way point location data element 404A-404D includes a respective way point location identifier, respective way point location GPS coordinates, and one or more respective links to corresponding digital photograph data files. Finally, the ending location data element includes an ending location ID, ending location GPS coordinates, and one or more ending location digital photograph data file links.

The GPS route data file 400 illustrated in FIG. 4 may be transmitted in a short message, an email message, or another format supported in a one or more digital communication networks. Thus, for example, one user may create the GPS route data file and make the GPS route data file accessible to any other user. Alternatively, a first user may create the GPS route data file intended for a second user and cause the GPS route data file to be transmitted to the second user after its creation. The second user may store the GPS route data file for subsequent use locally, remotely, or upon another storage device.

FIG. 5 is a diagram illustrating structure of a digital photograph data file according to an embodiment of the present invention. The digital photograph data file 500 illustrated in FIG. 5 includes a header 502, image data 504, and a tail 506. The header includes information relating to the image data 504. This information contained in the header 504 includes an image ID, time/data of capture, and may include additional information according to the present invention. This additional information includes one or more GPS coordinates of capture of the image data 504, the orientation of the capturing camera with respect to magnetic North, the azimuth of capture with respect to earth, local temperature at time of capture, humidity at time of capture, and/or barometric pressure at time of capture. The image data 504 is captured and stored according to a particular storage format, e.g., JPEG, TIFF, or another image format. Tail 506 includes error control and other information required at the end of the data file.

FIG. 6 is a flow chart illustrating GPS route usage operations according to an embodiment of the present invention. Operation 600 of FIG. 6 commences with a wireless terminal receiving a GPS route data file (Step 602). The GPS route data file received at Step 602 includes starting location GPS coordinates, ending location GPS coordinates, and at least one way point location data element. Each of the at least one way point location data elements includes respective way point location identifier, respective way point location GPS coordinate, and may include respective link to a corresponding digital photograph data file.

Operation continues with the wireless terminal presenting a map upon a display of the wireless terminal that includes the location respective to the starting location GPS coordinates and a then current location of the wireless terminal (Step 604). The operation of Step 604 may also include presenting a link to a photograph associated with the starting location. Further, the operation at Step 604 may include presenting a photograph associated with the starting location. By displaying not only the current location of the wireless terminal and the photograph associated with the starting location, the operation 600 of FIG. 6 allows a user of the wireless terminal to correctly position himself or herself at the starting location.

Operation continues with the wireless terminal selecting a next way point location from a plurality of way point locations included in the GPS route data file (Step 606). When there is an associated photograph with the way point location (as determined at Step 608), the wireless terminal may display the way point location on an illustrated map and display the associated photograph (Step 610). However, if no associated photograph exists (as determined at Step 608), the wireless terminal simply displays way point location on the map along with a current location of the wireless terminal on the map at Step 610.

When another way point location exists in the digital photograph data file (as determined at Step 612) operation returns to Step 606. However, when the way point locations of the GPS route data file has been exhausted, operation proceeds to Step 614 where the wireless terminal presents a map on its display indicating a current location of the wireless terminal and the ending location as indicated in the GPS route data file. Further, operation at Step 614 may include presenting on the display a photograph associated with the ending location. From Step 614, operation ends.

FIG. 7 is a topical area diagram with which operation of the present invention is described. The topical view of FIG. 7 illustrates an urban area that includes roads and buildings. Roads form intersections 702, 704, 706, and 708. Structures include store 710, library 712, museum 714, gas station 716, restaurant 718, park 720, museum 722, church 724, opera house 726, and tourist bureau 728. Also shown in FIG. 7 are a plurality of automobiles 730-742. Each of these automobiles 730-742 includes a wireless terminal capable of wirelessly communicating with one or more servicing infrastructures. Handheld wireless terminals 744, 746, and 748 are also capable of wirelessly communicating with one or more servicing infrastructures. These hand-held and automobile located wireless terminals 730-748 are constructed according to the present invention and will be further described herein with reference to FIG. 8.

According to a first aspect of the present invention, any of the wireless terminals of the automobile 730-748 of FIG. 7 is capable of generating a GPS route for using a GPS route according to the present invention. Thus, for example, any of the wireless terminals 730-748 may generate a GPS route according to the operations of FIG. 2 or FIG. 3. Further, any of the wireless terminals 730-748 may use a GPS route as described further herein with reference to FIG. 6. For example, the wireless terminal of automobile 738 may create a GPS route by driving along any of the roads selecting a starting location, starting an ending location, and selecting one or more way point locations along the route. Likewise, hand-held wireless terminal 746 may be used by a pedestrian to create a tour that includes a starting location, an ending location, and a plurality of way point locations. The user of wireless terminal 746 may select the tourist bureau 728 as a starting location. In doing so, the user of wireless terminal 746 may be present within/at the tourist bureau 728, indicate that the current location is the starting location, and take one or more photographs of the tourist bureau 728. Then, the user of wireless terminal 746 may proceed to opera house 726, to park 720, to museum 722, and to library 712, each of which is a way point location of the GPS route. At each of these points of interest 726, 722, and 712, the user of the wireless terminal 746 may cause the wireless terminal 746 to record the way point location and to take one or more digital photographs at these way point locations. Finally, the user of wireless terminal 746 completes the GPS route at museum 714. When at the museum 714, the user of wireless terminal 746 indicates that the museum 714 is the ending location for the GPS route. The user of wireless terminal 746 may further cause the wireless terminal to take a digital photograph at the museum 714 that corresponds to the ending location.

Likewise, automobile 736 (that includes a wireless terminal) may receive a GPS route and use the GPS route to navigate from a starting location, e.g., store 710 to an ending location, e.g., tourist bureau 728. This GPS route may include as way point locations the park 720 and the church 724. The creator of the GPS route may have included one or more digital photographs with GPS route. These digital photographs may be included with the starting location store 710, the ending location tourist bureau 728, and the way point locations of the park 720, and the church 724. For example, the way point location of the park 720 may include therewith a digital photograph of a statute present in the park 720 while the way point location of the church 724 may include a photograph of the church. By using this GPS route, the driver of automobile 736 may easily navigate from the starting location store 710 to the ending location tourist bureau 728.

FIG. 8 is a block diagram illustrating a wireless terminal constructed according to an embodiment of the present invention. The wireless terminal 800 includes processing circuitry 802, user interface 804, memory 806, communication interface 808, GPS receiver 820, compass/orientation detection circuitry 822, camera circuitry 824, and meteorological conditions sensors 826. The processing circuitry 802 may be a microprocessor, a digital signal processor, an application-specific integrated circuit, specialized circuitry, or another type of circuitry that is capable of executing software instructions and/or processing data. The user interface 804 may include a keypad, a display, a voice interface, or another type of interface that allows a user of wireless terminal 800 to interface with wireless terminal 800. The memory 806 may be random access memory, read only memory, optical memory, hard disk drive memory, or another type of memory that is capable of storing instructions and data. The communication interface 808 includes one or more of a cellular interface 812, a WLAN interface 814, a WiMAX interface 816, and a wired interface 818. The cellular interface 812 interfaces the wireless terminal 800 to one or more cellular networks and supports one or more communication protocol interface standards, such as the GSM standard, the WCMA standard, the UMTS standard, one or more CDMA standard, and/or another cellular standard. The WLAN interface 814 may support any of the IEEE 802.11 standards or another WLAN interface standard(s). The wired interface 818 may include a cable interface, an optical interface, or another wired interface. The GPS receiver 820 interfaces with GPS system satellites to receive signals from the satellites to determine a position of the wireless terminal 800 based upon such interaction.

The compass/orientation detection circuitry 822 may include a digital compass, and/or a mechanical and/or digital azimuth orientation determination sensor. The digital compass of the compass/orientation detection circuitry 822 detects orientation of the wireless terminal with respect to magnetic North. The azimuth detection sensor and circuitry of the compass/orientation detection circuitry 822 detects the relative position of the wireless terminal 800 with respect to the gravity of the earth. With the azimuth and compass information determined by the compass/orientation detection circuitry 822, when the wireless terminal takes a digital photograph using camera circuitry 824, a digital photograph data file created by the wireless terminal 800 may include capture orientation and capture azimuth along with GPS coordinates, image data and date and time of capture. Thus, a digital photograph data file captured by the wireless terminal 800 of FIG. 8 includes the GPS coordinates of capture, the orientation of capture (with respect to a magnetic bearing, the azimuth of capture, and additional information that was previously described with reference to FIG. 4. In combination, this information provides location and the direction (in three dimensional space) in which the image data was captured.

The meteorological conditions sensors 826 may include sensing devices capable of recording local meteorological conditions that include temperature, humidity, and/or barometric pressure proximate to the wireless terminal 800. The meteorological conditions may be included with an image captured by camera circuitry 824 when creating a digital photograph data file.

In another embodiment, the meteorological conditions data is transferred directly to one or more connected networks, e.g., WWAN 112, WLAN 116, Internet 102, etc., via the communication interface 808 to provide real-time data. A weather service or individual user may request temperature data from a desired region. A server, e.g., server 146 determines that the wireless terminal 800 is present within the region based upon GPS coordinates of the wireless terminal 800. Data captured by the meteorological conditions sensor(s) 826 could then be transferred directly a requesting terminal via the communication interface 808 and one or more servicing networks. If multiple wireless terminals are present in a region that is queried, an average value of the wireless terminals responding could be calculated and sent to the requestor. Likewise, data collected by wireless terminals residing in outlying areas could be excluded from averages to provide data that is more accurate. Data exclusion could be performed on the basis of statistical deviations from the mean or median temperature. These exclusions could also be based on more specific location information such as knowledge that the wireless terminal is located in a building that is air-conditioned.

The memory 806 stores a plurality of software instructions and data to support the operations of the present invention as well as additional operations. Operations of the present invention that are stored as software instructions and data in memory 806 include image capture operations and data, meteorological information capture instructions and data, GPS position instructions and data capture, as well as GPS route operations and data. These instructions and data support the operations previously described with reference to FIGS. 2-7 and those operations that will be subsequently described with reference to FIGS. 10-12.

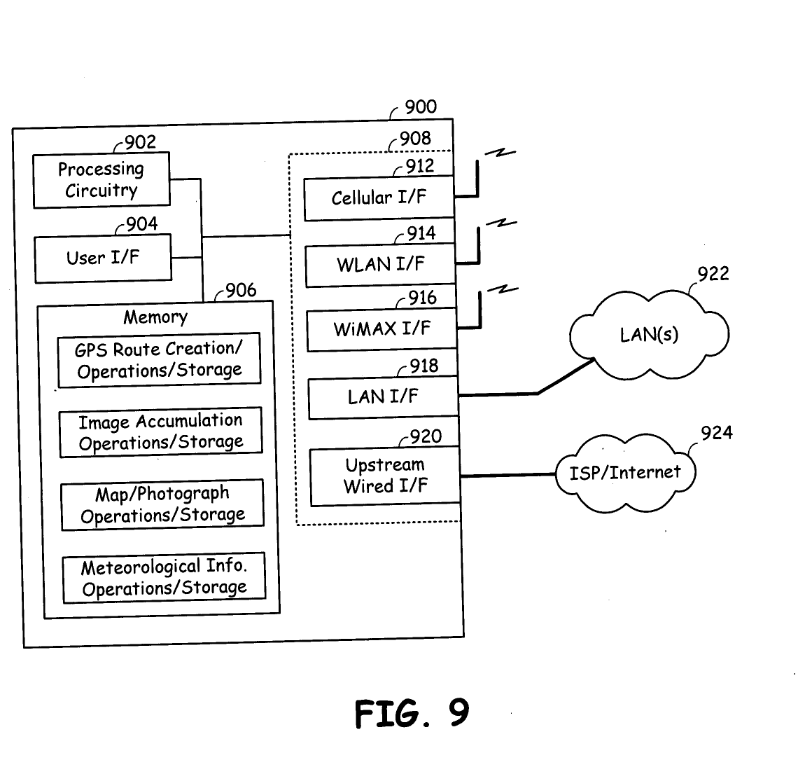

FIG. 9 is a block diagram illustrating a server constructed according to one or more embodiments of the present invention. The server 900 may be one or more of the image accumulation server 136, the GPS route generation server 138, the map/photograph server 144, and/or the meteorological data accumulation server 146 illustrated in FIG. 1. The server 900 includes processing circuitry 902, a user interface 904, memory 906, and a communication interface 908. As was the case with the wireless terminal 800, the processing circuitry 902 and the memory 906 may be various types of processors, circuitry, and/or storage devices. Further, the user interface 904 allows the user to interface with server 900. The communication interface 908 includes a cellular interface 912, a WLAN interface 914, a WiMAX interface 916, a LAN interface 918, and an upstream wired interface 920. The cellular interface 912 supports wireless communications between the server 900 and a cellular network. The WLAN interface 914 supports communication between the server 900 and one or more WLANs. The WiMAX interface 916 supports communications between the server 900 and a WiMAX network. The LAN interface 918 supports communications between the server 900 and a one or more LANs 922. Finally, the upstream wired interface 920 supports communications between the server 900 and an ISP network and/or the Internet 924.

Memory 906 stores instructions and data that enable operation according to the present invention as well as additional operations. Memory 906 in the server computer 900 stores software instructions and data that cause the server computer 900 to perform operations of one or more of the image accumulation server 136, the GPS route generation server 138, the map/photograph server 144, and/or the meteorological data accumulation server 146 illustrated in FIG. 1. These computer software instructions in storage include GPS route creation/modification/storage instructions and data, image accumulation operation/storage instructions and data, map/photograph operation/storage instructions and data, and meteorological information operation/storage instructions and data.

FIG. 10 is a flow chart illustrating map and digital photograph data file server operations according to an embodiment of the present invention. The method 1000 of FIG. 10 is performed by a server computer such as the map/photograph server 144 of FIG. 1. Operation commences with uploading a plurality of digital photograph data files to the server computer (Step 1002). Each digital photograph data file uploaded to the server includes image data and capture information. The capture information includes GPS coordinates, orientation, and azimuth of capture. Referring briefly to FIG. 8, when a wireless terminal 800 captures a digital photograph using camera circuitry 824 according to the present invention, it captures additional information as well. This additional information may be the orientation and azimuth of the camera lens coupled to camera circuitry 824 upon capture of the digital photograph. The capture information may also include a field of view of the camera that captures the digital photograph. Thus, upon further use of the digital photograph, a capture area may also be included that is relevant to stitching the photograph with additional photographs to create a panoramic view from a particular location of a point of interest.

Referring again to FIG. 10, operation 1000 continues with the server computer entering the digital photograph data files into a database (Step 1004). The digital photograph data files entered into the database may be indexed according to respective GPS coordinates. Operation continues with the server computer receiving a request to view a map of a respective geographic area by a client computer (Step 1006). Currently available systems on line allow a user to view satellite images of geographic features of the earth. The features available to the system allow the user to view any geographic area represented in the satellite image. Further, the system allows the user to zoom and un-zoom at different areas.

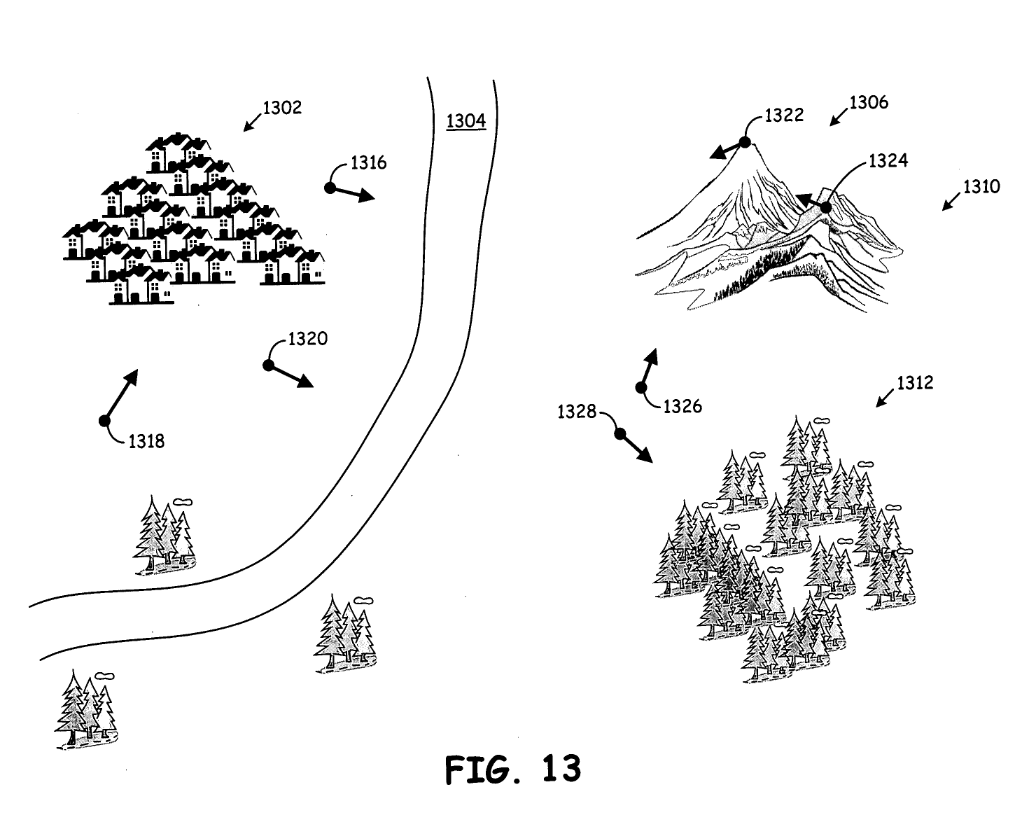

Based upon input received from the client computer, the server computer generates and transmits a map image to the client computer (Step 1008). The map image is transmitted across wired and/or wireless links between the server computer and the client computer. Operation continues with the server computer identifying at least one digital photograph data file respective to the geographic area of the map image (Step 1010). In identifying the at least one digital photograph data file, the server computer searches its database records based upon the GPS coordinates of the geographic area of the map image. With this selection complete, the server computer provides links to the digital photograph data files to the client computer (Step 1012). A number of differing digital photograph data files may be identified based upon the GPS area of the map image. The links provided to the client computer may be overlaid upon the map image sent to the client computer. For example, these links could include dots to indicate GPS coordinates, arrows to indicate the direction toward which the photo was taken and/or other attributes to indicate orientation of capture. Examples of these indications are described further with reference to FIGS. 13-15. Alternatively, a listing of links to digital photographs identified at Step 1010 may be provided to client computer for display to the user of client computer. Then, based upon a selection made by the user of the client computer, the server computer transmits a link digital photograph data file to the client computer (Step 1014). From Step 1014, operation ends.

In an alternate operation, one or more digital photographs identified by the server computer may be downloaded to the client computer along with the map image transmitted at Step 1008. Of course, the decision as to whether or not to download links digital photograph data files would depend upon the communication link characteristics between the server computer and the client computer, the processing and storage capabilities of client computer, and upon other information like user preferences.

According to another aspect to the present invention, the digital photograph data files that are identified by the server computer at Step 1010 may be stitched together to form a composite image respective to a particular GPS location of the map image transmitted at Step 1008. Such stitching of images may be performed prior to a request made by the client computer in anticipation of such request from the client computer. For example, some geographic locations are known to provide magnificent vistas of geographic and other features. Thus, according to the present invention, using a plurality of digital photographs taken at this location of interest, a composite image is constructed and then stored for later download to a client computer. Alternatively, the client computer could receive the plurality of digital photograph data files and perform stitching of the digital photograph represented therein to perform a composite image.

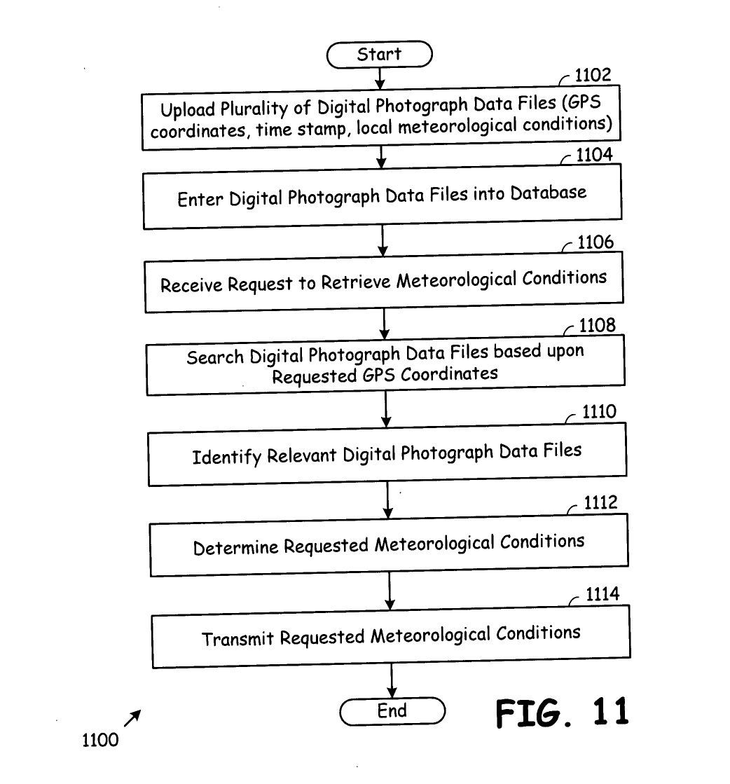

FIG. 11 is a flow chart illustrating digital photograph data file and meteorological data server operations according to a first embodiment of the present invention. The method 1100 of FIG. 11 commences with uploading a plurality of digital photograph data files from a client computer to a server computer (Step 1102). Each digital photograph data file includes image data and capture information. The capture information may include global GPS coordinates of the digital photograph, a time stamp of the digital photograph, and local meteorological conditions as captured by the wireless terminal providing the digital photograph data file. Referring briefly to FIG. 8, a wireless terminal 800 upon capturing a digital image with camera circuitry 824 may also capture meteorological conditions local to the wireless terminal 800 using its meteorological conditions sensors 826. Then, in creating a digital photograph data file based upon the captured image, the wireless terminal 800 appends thereto the captured local meteorological conditions, which may include one or more temperature, humidity, barometric pressure, and other meteorological conditions.

Referring again to FIG. 11, operation continues with the server computer entering each received digital photograph data filed into a database based upon respective GPS coordinates (Step 1104). Then, from time to time, the server computer may receive a request from a client computer to receive meteorological conditions respective to requested GPS coordinates (Step 1106). In response to this request, the server computer searches its digital photograph data files based upon requested GPS coordinates (Step 1108). By searching the digital photograph data files based upon the requested GPS coordinates (Step 1108), the server computer identifies at least one digital photograph data file respective to the requested GPS coordinates based upon GPS coordinates of the at least one digital photograph data file (Step 1110). Then, based upon the capture information of the at least one digital photograph data file respective the requested GPS coordinates, the server computer determines requested meteorological conditions based upon the local meteorological conditions of the capture information of the at least one digital photograph data file (Step 1112). The server computer then transmits the requested meteorological conditions to client computer (Step 1114). From Step 1114, operation ends.

The operations of FIG. 11 may include parsing from time to time the database to exclude from its search digital photograph data files that are aged such that their capture information is no longer relevant to the requested meteorological conditions. Alternately, at Step 1112, the server computer may simply ignore digital photograph data files whose local meteorological conditions are not current. In such case, the server computer may simply ignore digital photograph data files whose time stamp fails to satisfy a currency requirement. Further, in another embodiment, wireless terminals may be queried directly to provide meteorological information. In response thereto, the wireless terminals simply respond to a servicing network with the meteorological information in response to the request in a real-time manner without necessitating the creation or transfer of an image data file.

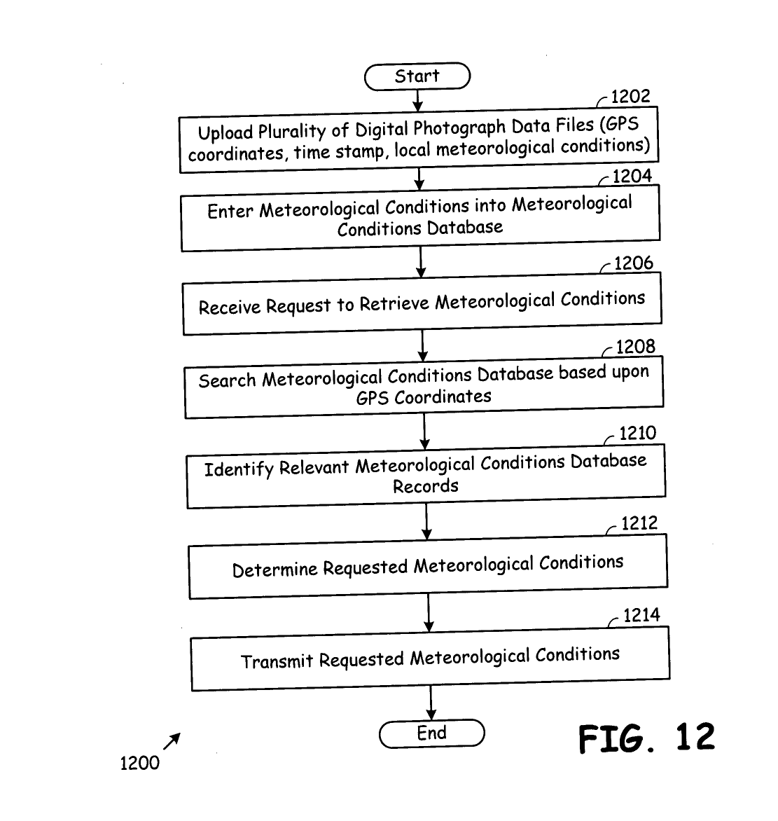

FIG. 12 is a flow chart illustrating digital photograph data file and meteorological data server operations according to a second embodiment of the present invention. The operations 1200 of FIG. 12 begin with the uploading of a plurality of digital photograph data files to a server computer from wireless terminals that capture the plurality of digital photograph data files (Step 1202). Each digital photograph data file includes image data and capture information. The capture information includes GPS coordinates, a time stamp, and local meteorological conditions respective to the wireless terminal at time of capture of the digital photograph.

Operation 1200 continues with the server computer entering portions of the plurality of digital photographs data files into a meteorological conditions database (Step 1204). The portions of the digital photograph data files that are stored include GPS coordinates, local meteorological conditions, and time stamps respective to the plurality of digital photograph data files.

Operation continues with the server computer receiving requests from a client computer to receive meteorological conditions respective to requested GPS coordinates (Step 1206). Based on this request, the server computer searches its database (Step 1208) and identifies (Step 1210) at least one local meteorological condition database record based upon the requested GPS coordinates and GPS coordinates of the at least one local meteorological conditions database record. The server computer then determines the requested meteorological conditions based upon local meteorological conditions so the at least one local meteorological conditions database record (Step 1212). The server computer then transmits the requested meteorological conditions to the client computer (Step 1214). From Step 1214, operation ends.

As was the case of the operations 1100 of FIG. 11, the operations 1200 of FIG. 12 also consider time stamp information in servicing and satisfying the request from the client computer. Thus, in its search, the server computer may simply ignore records in the meteorological conditions database that are not current. Further, the server computer may weight these records less than records retrieved in the search that are more current.

In an alternate embodiment, a user of a client computer could request digital photograph files by querying or filtering the data or metadata (such as temperature, date, time, humidity, etc) associated with various digital photograph files on the image server. For example, this would allow the user to be able to request digital photograph files of a scenic view such as that of a national monument when snow was present as opposed to warmer conditions that would not contain the same image characteristics.

FIGS. 13-15 are pictorial representations of a three-dimensional graphical model that may be used to provide a virtual tour according to aspects of the present invention. Referring now to FIG. 13, an image may be presented to a user terminal, e.g., client computer 127 of FIG. 1, that depicts a three-dimensional graphical model for a virtual tour. As shown, the image depicts buildings 1302, river 1304, mountains 1306 and 1310, and forest 1312. Further indicated on this three-dimensional graphical model are indications of actual photographs captured related to the image. The client computer 127 may receive the image in response to a request sent relating to a geographic map or satellite image of a given region. A server, e.g., server 144 of FIG. 1, overlays known image data points (digital photograph files) and their capture angles on the image, and delivers the image to the client computer 127. Image data points shown on FIG. 13 include image data points 1316-1328. As shown, each of these image data points indicate capture location and relative capture direction/azimuth with respect to the features (1302, 1304, 1306, 1310, and 1312) shown in the image.

A user of the client computer 127 could select any of the image data points 1316-1328 via mouse cursor movement and click, for example. In response thereto, the client computer 127 and the server 144 interact to present corresponding digital photographs to the user via the client computer 127.

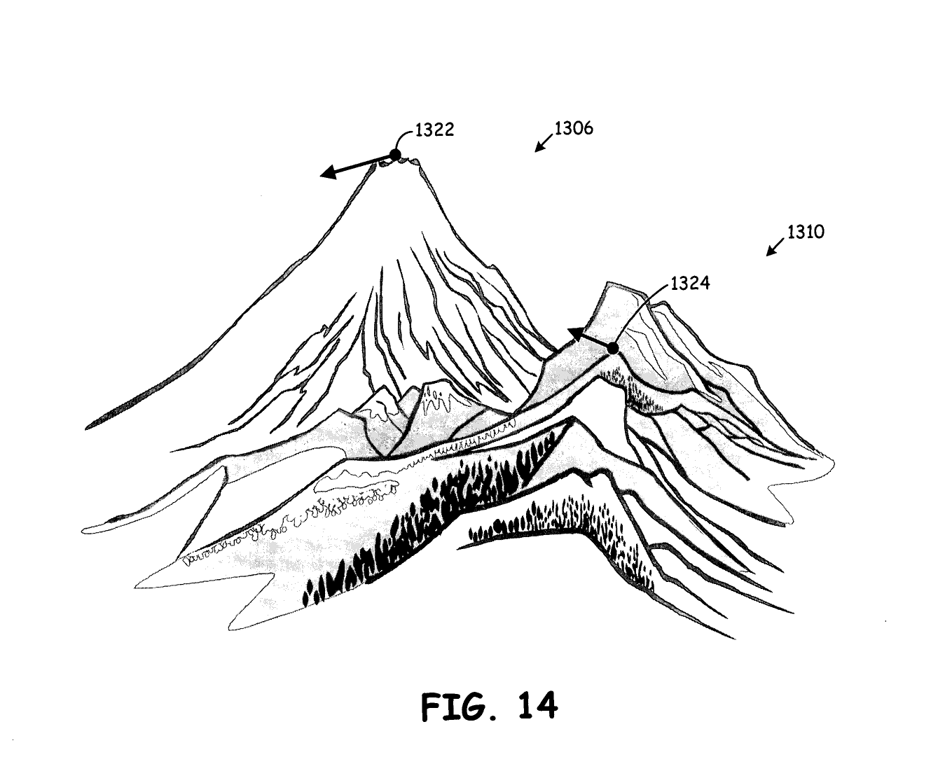

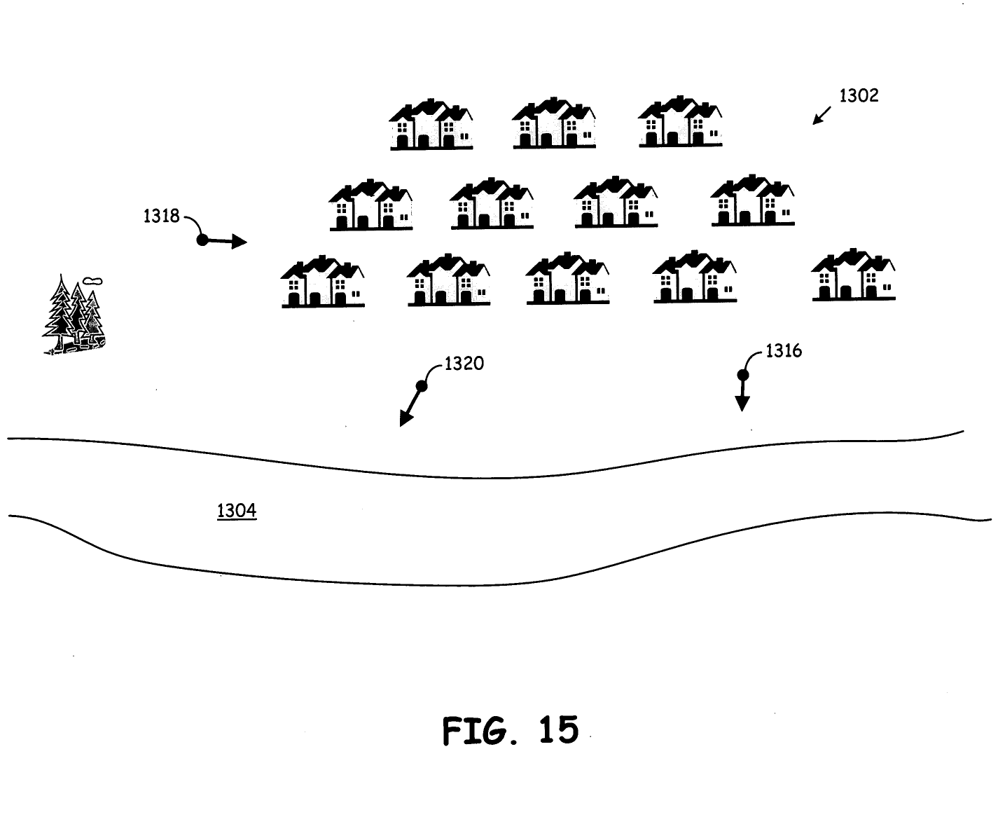

Referring now to FIG. 14, the server computer 144 could run calculations, based on its three-dimensional geographic model, to identify additional digital photograph files associated with the region that the angle of the image of FIG. 14 captures. These new digital photograph files and their associated capture angles could then be overlaid by the server computer 144 on the image that is transferred to the client computer 127. The user of the client computer 127 could then click on one of the links to the associated digital photograph files and then be presented with another digital photograph file. As an example, the user could choose the image data file link 1322 in FIG. 14 and be presented with yet another digital photograph file shown in FIG. 15 that contains even more overlaid links of digital photograph files and their associated capture angles. This process could continue indefinitely. The result to the user of the client computer 127 could be that they could experience virtual tours of geographic regions by moving from links in one digital photograph file to the next.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method for creating a Global Positioning System (GPS) route comprising:
selecting a starting location from a database that includes starting location GPS coordinates;
selecting an ending location from the database that includes ending location GPS coordinates;
selecting at least one way point location from the database that includes respective way point location GPS coordinates;
for the at least one way point location, creating an association between the way point location and a digital photograph data file, the digital photograph data file representing a photograph taken at the way point location; and
creating a GPS route data file that includes:
the starting location GPS coordinates;
the ending location GPS coordinates; and
at least one way point location data element that includes:
respective way point location GPS coordinates; and
a respective link to a corresponding digital photograph data file.

2. The method of claim 1, wherein the digital photograph data file comprises:
date and time of capture;
GPS coordinates of capture;
capture orientation information;
capture azimuth information; and
image data.

3. The method of claim 1, further comprising, for the starting location, creating an association between the starting location and a digital photograph data file, the digital photograph data file representing a photograph taken at the starting location.

4. The method of claim 1, further comprising electronically transmitting the GPS route data file to a destination wireless terminal.

5. The method of claim 1, further comprising remotely accessing a server computer from a user terminal to create the GPS route.

6. A method for creating a Global Positioning System (GPS) route by a wireless terminal having a user interface and an associated camera, the method comprising:
selecting a starting location by:
receiving user input via a user interface to indicate presence at the starting location;
based upon the user input, determining starting location GPS coordinates of the wireless terminal; and
storing a starting location identifier and the starting location GPS coordinates;
for each of at least one waypoint location:
receiving user input via the user interface to indicate presence at the waypoint location;
based upon the user input, determining waypoint GPS coordinates of the wireless terminal;
the associated camera capturing an image of a way point location reference; and
storing a waypoint location identifier, the waypoint GPS coordinates, and a link to a digital photograph data file containing the image of the way point location reference; and
selecting an ending location by:
receiving user input via a user interface to indicate presence at the ending location;
based upon the user input, determining ending location GPS coordinates of the wireless terminal; and
storing an ending location identifier and the ending location GPS coordinates.

7. The method of claim 6, further comprising creating a GPS route data file that includes:
the starting location GPS coordinates;
the ending location GPS coordinates; and
at least one way point location data element that includes:
respective way point location GPS coordinates; and
a respective link to a corresponding digital photograph data file.

8. The method of claim 7, further comprising electronically transmitting the GPS route data file to a destination wireless terminal.

9. The method of claim 6, wherein the digital photograph data file comprises:
date and time of capture;
GPS coordinates of capture;
capture orientation information;
capture azimuth information; and
image data.

10. The method of claim 6, further comprising, for the starting location, creating an association between the starting location and a digital photograph data file, the digital photograph data file representing a photograph taken at the starting location.

11. The method of claim 7, wherein the digital photograph data file is stored on a remote computer.

12. A method for using a Global Positioning System (GPS) route by a wireless terminal, the method comprising:
receiving a GPS route data file that includes:
starting location GPS coordinates;
ending location GPS coordinates; and
at least one way point location data element that includes:
respective way point location GPS coordinates; and
a respective link to a corresponding digital photograph data file.
presenting a map upon a display of the wireless terminal that includes a location respective to the starting location GPS coordinates and a then current location of the wireless terminal;
for the at least one way point location:
presenting a map upon the display that includes a location respective to the GPS coordinates of the way point location and a then current location of the wireless terminal; and
displaying a digital photograph taken at the way point location; and;
presenting a map upon a display of the wireless that includes a location respective to the ending location GPS coordinates and a then current location of the wireless terminal.

13. The method of claim 12, wherein the digital photograph data file comprises:
date and time of capture;
GPS coordinates of capture;
capture orientation information;
capture azimuth information; and
image data.

14. The method of claim 12, further comprising displaying a digital photograph that represents a starting location reference on the display when the wireless terminal is proximate the starting location.

15. The method of claim 12, further comprising displaying a digital photograph that represents an ending location reference on the display when the wireless terminal is proximate the ending location.

16. The method of claim 12, further comprising remotely accessing a server computer by the wireless terminal to receive the GPS route data file.

17. The method of claim 12, further comprising remotely accessing a server computer by the wireless terminal to receive the digital photograph.

18. A wireless terminal comprising:
a user interface including a display;
at least one communication interface;
a Global Positioning System (GPS) receiver;
memory; and
processing circuitry coupled to the user interface, to the at least one communication interface, to the GPS receiver, and to the memory and operable to:
receive a route data file via the at least one communication interface that includes:
starting location GPS coordinates;
ending location GPS coordinates; and
at least one way point location data element that includes:
respective way point location GPS coordinates; and
a respective link to a corresponding digital photograph data file;
present a map upon the display that includes a location respective to the starting location GPS coordinates and a then current location of the wireless terminal;
for the at least one way point location:
present a map upon the display that includes a location respective to the GPS coordinates of the way point location and a then current location of the wireless terminal; and
display a digital photograph taken at the way point location; and;
present a map upon a display of the wireless that includes a location respective to the ending location GPS coordinates and a then current location of the wireless terminal.

19. The wireless terminal of claim 18, wherein the digital photograph data file comprises:
date and time of capture;
GPS coordinates of capture;
capture orientation information;
capture azimuth information; and
image data.

20. The wireless terminal of claim 18, the processing circuitry further operable to:
present a digital photograph on the display that represents a starting location reference on the display when the wireless terminal is proximate the starting location; and
displaying a digital photograph that represents an ending location reference on the display when the wireless terminal is proximate the ending location.

21. A method comprising:
uploading a plurality of digital photograph data files to a server computer, each digital photograph data file including image data and capture information, the capture information including Global Positioning System (GPS) coordinates, orientation, and azimuth of capture;
the server computer entering each of the digital photograph data files into a database;
the server computer receiving a request to view a map of a respective geographic area by a client computer;
the server computer transmitting a corresponding map image to the client computer;
the server computer identifying at least one digital photograph data file respective to the geographic area based upon GPS coordinates of the geographic area and GPS coordinates of the at least one digital photograph data file;
the server computer providing, to the client computer, a link to the at least one digital photograph data file; and
the server computer transmitting a linked digital photograph data file to the client computer.

22. The method of claim 21, wherein the server computer transmitting a linked digital photograph data file to the client computer is based upon a selection received from the client computer.

23. A method comprising:
uploading a plurality of digital photograph data files to a server computer, each digital photograph data file including image data and capture information, the capture information including Global Positioning System (GPS) coordinates, a time stamp, and local meteorological conditions;
the server computer entering each of the digital photograph data files into a database;
the server computer receiving a request from a client computer to receive meteorological conditions respective to requested GPS coordinates;
the server computer identifying at least one digital photograph data file respective to the requested GPS coordinates based upon GPS coordinates of the at least one digital photograph data file;
the server computer determining the requested meteorological conditions based upon local meteorological conditions of the at least one digital photograph data file; and
the server computer transmitting the meteorological conditions to the client computer.

24. The method of claim 23, wherein the server computer identifying at least one digital photograph data file respective to the requested GPS coordinates and GPS coordinates of the at least one digital photograph data file further includes considering time stamps of the at least one digital photograph data file.

25. The method of claim 24, further comprising at least one electronic device capturing the plurality of digital photograph data files.

26. The method of claim 23, wherein the local meteorological conditions comprise at least one of temperature, humidity, and barometric pressure.

27. A method comprising:
uploading a plurality of digital photograph data files to a server computer, each digital photograph data file including image data and capture information, the capture information including Global Positioning System (GPS) coordinates, a time stamp, and local meteorological conditions;
the server computer entering portions of the plurality of digital photograph files into a meteorological conditions database, the portions including GPS coordinates, meteorological conditions, and time stamps respective to the plurality of digital photograph data files;
the server computer receiving a request from a client computer to receive meteorological conditions respective to requested GPS coordinates;
the server computer identifying at least one local meteorological conditions database record based upon to the requested GPS coordinates and GPS coordinates of the at least one local meteorological conditions database record;
the server computer determining the requested meteorological conditions based upon local meteorological conditions of the at least one local meteorological conditions database record; and
the server computer transmitting the requested meteorological conditions to the client computer.

28. The method of claim 27, further comprising at least one electronic device capturing the plurality of digital photograph data files.

29. The method of claim 27, wherein the local meteorological conditions comprise at least one of temperature, humidity, and barometric pressure.

30. The method of claim 27, wherein the server computer identifying at least one local meteorological conditions database record based upon to the requested GPS coordinates and GPS coordinates of the at least one local meteorological conditions database record further includes considering time stamps of the at least one local meteorological conditions database record.
